(19) United States
(12) Patent Application Publication
(10) Pub. No.: US 2009/0023836 A1
(43) Pub. Date: Jan. 22, 2009

(54) ENVIRONMENTALLY DEGRADABLE POLYMERIC COMPOSITION AND METHOD FOR OBTAINING AN ENVIRONMENTALLY DEGRADABLE POLYMERIC COMPOSITION

(75) Inventors: Jefter Fernandes Nascimento, Sao Paulo City (BR); Wagner Mauricio Pachekoski, Sao Carlos (BR); Jose Augusto Marcondes Agnelli, Sao Carlos (BR)

Correspondence Address: DARBY & DARBY P.C., P.O. BOX 770, Church Street Station, New York, NY, 10008-0770, US

(73) Assignee: PHB INDUSTRIAL S.A., Serrana - SP (BR)

(21) Appl. No.: 12/280,411

(22) PCT Filed: Feb. 23, 2007
(86) PCT No.: PCT/BR2007/000048

§ 371 Date: Sep. 15, 2008

(30) Foreign Application Priority Data
Feb. 24, 2006 (BR) PI0600787-2

(51) Int. Cl. C09K 3/00; C08K 11/00

(52) U.S. Cl. 523/124; 523/128

(57) ABSTRACT

The environmentally degradable polymeric composition is obtained from the biodegradable polymers poly (hydroxybutyrate)-PHB and copolymers thereof and poly (lactic acid)-PLA and, optionally, at least one of the additives defined by: plasticizer of natural origin, such as natural fibers; natural fillers; thermal stabilizer; nucleant; compatibilizer; surface treatment agent; and processing aid.

### FIELD OF THE INVENTION

The present invention refers to an environmentally degradable polymeric composition obtained from the biodegradable polymers poly (hydroxybutyrate)-PHB and its copolymers and poly (lactic acid) - PLA. The invention further refers to a process for obtaining said composition, utilizing the extrusion technique for obtaining an adequate morphology in the distribution, dispersion and integration of the polymers, so as to conduct to compatible polymeric blends. The process allows the polymeric composition granules to be utilized in the production of several products molded by injection.

### PRIOR ART

There are known from the prior art different biodegradable polymeric materials and techniques for processing them, such as extrusion for example, so as to obtain materials with adequate morphology in the distribution of their compounds, in the dispersion and in the interaction of the polymers, in order to obtain biocompatible polymeric blends.

Polymeric blend is the term adopted in the technical literature about polymers, to represent the physical mixtures or mechanical mixtures of two or more polymers, so that among the molecular chains of the different polymers only exist secondary intermolecular interaction or in which there is not a high degree of chemical reaction among the molecular chains of the different polymers. Many polymeric blends are utilized as engineering plastics, with applications mainly in the automobilistic and electro-electronic industries and in countless other industrial segments. Among the polymers that form these polymeric blends, there is a great predominance of employing conventional polymers.

Recently, it has been possible to detect the increasing interest in the employment of biodegradable polymers, which are environmentally correct. However, most of the patents about biodegradable polymers are related to polymer production and only few are related to their applications in polymeric blends, including the biodegradability of these new polymeric materials.

In the attempt to generate alterations in the characteristics of processability and/or mechanical properties, there has been proposed some modifications for the Poly (hydroxybutyrate)-PHE, such as the formation of polymeric blends with other biodegradable polymers, associated or not with other possibilities of additivation. Such developments are frequently carried out in laboratory processes and/or utilize manual molding techniques with no industrial productivity.

Thus, there were found citations of miscible and compatible polymeric blends, formed by the PHB with the polymers: poly (vinyl acetate)-PVAc, polyepichloridrine-PECH, poly(vinylidene fluoride)-PVDF, poly (R,S) 3-hydroxybutyrate copolymer, poly(ethylene glycol)-P(R,S-HB-b-EG), and poly(methil methacrylate)-PMMA. There were also found citations of unmiscible and compatible polymeric blends, based on the mixture of the PHB with: poly (1,4 butylene adipate)-PBA, ethylene-propylene rubbers (EPR); ethylene vynil-acetate (EVA), modified EPR (grafted with succinic anhydride (EPR-g-SA) or with dibutyl maleate (EPR-DBM)), modified EVA containing group-OH (EVAL) and polycyclo-hexyl methacrylate-PCHMA, poly (lactic acid)-PLA and polycaprolactone-PCL.

On the other hand, the citations found about production processes, compositions and applications of polymeric blends consisting of the PHB-PLA pair differ from the innovative characteristics of the present invention in the following aspects:
technology of obtaining compatible PHB-PLA polymeric blends, since in the developed process is utilized a modular twin screw extruder, having a screw profile designed based on the rheologic behavior of PHB and PLA polymers; this allows a satisfactory dispersion and an optimal distribution of the polymers, generating an adequate and stable morphology, resulting in PHB/PLA polymeric blends with higher physicochemical performance.
possibility of wide variation of the contents of the constitutive polymer, producing tailored polymeric materials from the intrinsic characteristics of these components.
possibility to modify these polymeric blends with other additives, such as natural fibers and natural fillers and lignocellulosic residues.
utilization of two methods with commercial viability: extrusion process for obtaining PHB/PLA polymeric blends and injection molding for obtaining products.

### SUMMARY OF THE INVENTION

As a function of the deficiencies related to degradability of the known polymeric compositions and the costs involved in its production and discard, it is an object of the present invention to provide an environmentally degradable polymeric composition, easily obtained from biodegradable polymers and additional components obtained from renewable sources.

It is a further object of the present invention to provide a process for obtaining said environmentally degradable polymeric composition.

According to a first aspect of the invention, an environmentally degradable polymeric composition comprises a biodegradable polymer, defined by poly(hydroxybutyrate) (PHB) or its copolymers; one poly (lactic acid)-PLA; and, optionally, at least one of the additives defined by: plasticizer of natural origin, such as natural fibers and natural fillers.

According to a second aspect of the present invention, the method to prepare said environmentally degradable polymeric composition comprises the steps of:
a) pre-mixing the materials that constitute the formulation of interest; b) drying said materials; extruding the pre-mixed materials so as to obtain their granulation; and c) injection molding the extruded and granulated material to produce injected packages and other injected products.

### DETAILED DESCRIPTION OF THE INVENTION

Within the class of the biodegradable polymers, the structures containing ester functional groups are of great interest, mainly due to their usual biodegradability and versatility in physical, chemical and biological properties. Produced by a large variety of microorganisms, as a source of energy and carbon, the polyalkanoates (polyesters derived from carboxylic acids) can be synthesized either by biological fermentation or chemically.

The poly (hydroxybutyrate)-PHB is the main member of the class of the polyalkanoates. Its great importance is justified by the combination of 3 important factors: it is 100% biodegradable, it is resistant-water and it is a thermoplastic polymer, enabling the same applications as the conventional thermoplastic polymers. FIG. 1 presents the structural formula of the PHB.

Structural formula of the (a) 3-hydroxybutyric acid and (b) Poly (3-hydroxybutyric acid)-PHB.

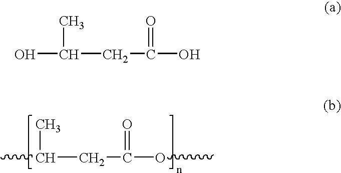

PHB was discovered by Lemognie in 1925 as a source of energy and carbon storage in microorganisms, as in the bacteria Alcaligenis euterophus, in which, under optimal conditions, above 80% of the dry weight is of PHB. Nowadays, the bacterial fermentation is the main production source of the poly (hydroxybutyrate), in which the bacteria are fed in reactors with butyric acid or fructose and left to grow, and after some time the bacterial cells are extracted from the PHB with an adequate solvent.

In Brazil, PHB is industrially produced by PHB Industrial S/A, the only Latin America Company that produces poly-hydroxyalkanoates (PHAS) from renewable sources. The production process of the poly (hydroxybutyrate) is basically constituted of two steps:
fermentative step: in which the microorganisms metabolize the sugar available in the medium and accumulate the PHB in the interior of the cell as source of reserve;
extracting step: in which the polymer accumulated in the interior of the cell of the microorganism is extracted and purified until a solid and dry end product is obtained.

The project developed by PHB Industrial S.A. permitted to utilize sugar and/or molasse as basic constituents of the fermentative medium, the fusel oil (organic solvent—byproduct of the alcohol manufacture) as an extraction system of the polymer synthesized by the microorganisms, as well as permitted the use of the excess of sugarcane bagasse to produce energy (vapor generation) for these processes. This project allowed a perfect vertical integration with the maximum utilization of byproducts generated in the sugar and alcohol manufacture, generating processes that utilize the so-called clean and ecologically correct technologies.

Through a production process similar to that of the PHB, it is possible to produce a semicrystalline bacterial copolymer of 3-hydroxybutyrate with random segments of 3-hydroxyvalerate, known as PHBV. The main difference between the two processes is based on the increase of proprionic acid in the fermentative medium. The quantity of proprionic acid in the bacteria feeding is responsible for controlling the hydroxyvalerate concentration—HV in the copolymer, enabling the variation of degradation time (which can be from some weeks to several years) and certain physical properties (molar mass, degree of crystallinity, surface area, for example). The composition of the copolymer further influences the melting point (which can range from 120 to 180° C.), and the characteristics of ductility and flexibility (which are improved with the increase of PHV concentration) FIG. 2 presents a basic structure of the PHBV.

Basic Structure of the PHBV.

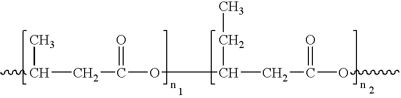

According to some studies, the PHB shows a behavior with some ductility and maximum elongation of 15%, tension elastic modulus of 1,4 GPa and notched IZOD impact strength of 50 J/m soon after the injection of the specimens. Such properties modify as time goes by and stabilize in about one month, with the elongation reducing from 15% to 5% after 15 days of storage, reflecting the fragilization of the material. The tension elastic modulus increases from 1.4 GPa to 3 GPa, while the impact strength reduces from 50 J/m to 25 J/m after the same period of storage. Table 1 presents some properties of the PHB compared to the Isostatic Polypropylene (commercial Polypropylene).

TABLE 1
Comparison of the PHB and the PP properties.

| | PHB | PP |
|---|---|---|
| Degree of crystallinity (%) | 80 | 70 |
| Average Molar mass (g/mol) | 4 × 10⁵ | 2 × 10⁵ |
| Melting Temperature (° C.) | 175 | 176 |
| Glass Transition | −5 | −10 |
| Temperature (° C.) | | |
| Density (g/cm³) | 1.2 | 0.905 |
| Modulus of Flexibility | 1.4-3.5 | 1.7 |
| (GPa) | | |
| Tensile strength (MPa) | 15-40 | 38 |
| Elongation at break (%) | 4-10 | 400 |
| UV Resistance | good | poor |
| Solvent Resistance | poor | good |

Of great relevance for the user of articles made of PHB or its Poly (3-hydroxybutyric-co-hydroxyvaleric acid)-PHBV copolymers are the degradation rates of these articles under several environmental conditions. The reason that makes them acceptable as potential biodegradable substitutes for the synthetic polymers is their complete biodegradability in aerobic and anaerobic environments to produce CO₂/H₂O/biomass and CO₂/H₂O/CH₄/biomass, respectively, through natural biological mineralization. This biodegradation usually occurs via surface attack by bacteria, fungi and algae. The actual degradation time of the biodegradable polymers and, therefore, of the PHB and PHBV, will depend upon the surrounding environment, as well as upon the thickness of the articles.

The PHB or the PHBV may or not contain plasticizers of natural origin, specifically developed to plasticize these biodegradable polymers, as mentioned ahead.

Poly (Lactic Acid)-PLA

The poly (lactic acid) or polylactide-PLA has been attracting attention in the last years, due to its biocompatibility with fabrics, degradability in vitro and in vivo and good mechanical properties. Table 2, below, shows some PLA properties of interest, compared with the properties of the poly (ethylene terepthalate)-PET.

TABLE 2
Comparison of PLA and PET properties.

| | PET | PLA |
|---|---|---|
| Inflammability | burn 6 minutes | Burn 2 minutes |
| | after removal from | after removal from |
| | the flame | the flame |
| Resilience | 51% of | 64% of recuperation |
| | recuperation with | with 10% of |
| | 10% of deformation | deformation |
| Re-covery | poor | Good |
| Gloss | Medium up to low | Very high up to low |
| Wrinkling | good | Excellent |
| resistance | | |
| Density | 1.34 g/cm³ | 1.25 g/cm³ |

The PLA is not a polymer of recent discovery: Carothers produced a low molecular weight product by vacuum heating the lactic acid. Nowadays, this material is produced by several industries from cornstarch.

The mixture of poly (lactic acid) with poly (glycolic acid)-PGA was the first tentative of commercial use of this material. With the trademark Vicryl® this polymeric mixture was developed to be used in surgical sutures. Nowadays, the PLA is utilized not only in the medical field (prostheses, implants, sutures and lozenges), but also in the textile area and manufacture of products in general.

As already mentioned above, the PLA has good biocompatibility and excellent mechanical properties. Nevertheless, one of the main disadvantages of the PLA lies in its material transition from ductile to fragile under stress due to the physical action. Thus, several polymeric mixtures with the poly-(lactic acid) were studied, in order to improve their properties and processability. Among these, one of most outstanding polymeric blends is the mixture of the poly (lactic acid) and the poly (hydroxybutyrate)-PHB.

Modifiers and Other Additives that can be Incorporated in the PHB/PLA Polymeric Blends

Plasticizer: the plasticizer is an “in natura” (as found in nature) vegetable oil or its ester or epoxy derivative coming from soybean, corn, castor-oil, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and their possible hydrogenated derivatives, present in the composition in a mass proportion lying from about 2% to 30%, preferably from about 2% to about 15%, and more preferably from about 5% to about 10%. The plasticizer comprises a fatty composition ranging from: 45-63% of linoleates, 2-4% of linolenates, 1-4% of palmitates, 1-3% of palmitoleates, 12-29% of oleates, 5-12% of .stearates, 2-6% of miristates, 20-35% of palmistates, 1-2% of gadoleates e 0,5-1,6% of behenates.

Natural fibers: the natural fibers that can be utilized in the developed process are: sisal, sugarcane bagasse, coconut, piasaba, soybean, jute, ramie and curaua (Ananas lucidus), present in the composition in a mass proportion lying from about 5% to about 70%, and more preferably, from about 10% to about 60%.

Natural fillers: the lignocellulosic fillers that can be utilized in the developed process are: wood flour or wood dust, starches and rice husk, present in the composition in a mass proportion lying from about 5% to about 70%, and more preferably, from about 10% to about 60%.

Processing aid/dispersant: optional utilization of processing aid/dispersant specific for compositions with thermoplastics, in the quantity of 1% in relation to the total content of de modifiers. The processing aid is preferably the “Struktol” product (commercialized by Struktol Company of America), and is present in the composition in a mass proportion lying from about 0.01% to about 2%, preferably, from about 0.05% to about 1%.

Nucleants : boron nitride or HPN® of Milliken.

Surface treatment agent: is selected from: silane, titanate, zirconate, epoxi resin, stearic acid and calcium stearate, present in the composition in a mass proportion lying from about 0.01% to about 2%.

Compatibilizer: this additive is selected from: polyolefine functionalized or grafted with anhydride maleic; ionomer based on copolymer ethylene—acrylic acid or ethylene-methacrylic acid neutralized with sodium (Surlin trademark from DuPont), present in the composition in a mass proportion lying from about 0.01% to about 2%, preferably from about 0.05% to about 1%.

Other additives of optional use: thermal stabilizers—primary antioxidant and secondary antioxidant, pigments; ultraviolet stabilizers of the oligomeric HALS type (sterically hindered amine). The stabilizer additive is selected from primary antioxidant, secondary antioxidant or ultraviolet stabilizers of the oligomeric HALS type (sterically hindered amine), present in the composition in a mass proportion lying from about 0.01% to about 2%, preferably from about 0.05% to about 1%, and more preferably from about 0.1% to about 0.5%.

Production Process of the Polymeric Blends Developed Methodology and Formulations of the Polymeric Blends

The generalized methodology developed to prepare the PHB/Poly (lactic acid)-PLA polymeric blends is based on five steps, which can be compulsory or not depending on the specific object desired for a particular biodegradable mixture.

The preparation steps of the PHB/ PLA polymeric blends are:

a. Defining the formulations

b. Drying the biodegradable polymers and the other optional components

c. Pre-mixing the components

d. Extruding and Granulating

e. Injection molding to produce several products

Description of the Steps

a. Defining the Formulations Table 3 presents the main formulations of the PHB/PLA polymeric blends.

TABLE 3
Formulations of the PHB/PLA polymeric blends, including
the modifiers and other optional additives.

| | CONTENT RANGE |
|---|---|
| COMPONENTS | (% IN MASS) |
| Biodegradable Polymer 1: PHB or | 10-90% |
| PHBV, containing or not up to 6% of | |
| plasticizer of natural origin | |
| Biodegradable polymer 2: Poly | 10-90% |
| (lactic acid) - PLA | |
| Natural fiber 1* | 0-30% |
| Natural fiber 2** | |
| Lignocellulosic filler*** | 0-30% |
| Processing aid/Dispersant/ | 0-0.5% |
| Nucleant | |
| Thermal stabilization system - | 0-0.3% |
| Primary antioxidant:Secondary | |
| antioxidant (1:2) | |
| Pigments | 0-2.0% |
| Ultraviolet stabilizers | 0-0.2% |

*sisal or sugarcane bagasse or coconut or piasaba or soybean or jute or ramie or curaua (Ananas lucidus).
**any one of the natural fibers employed, except the fiber selected as natural fiber 1.
***wood flour, starches or rice husk.

b. Drying the Biodegradable Polymers and the Other Optional Components

The PHB and PLA biodegradable polymers and the other possible modifiers must be adequately dried before the processing operations, which will result in the production of the polymeric blends. The content of the residual moisture must be quantified by Thermogravimetry or by other equivalent analytical technique.

c. Pre-Mixing of the Components

The biodegradable polymers and other optional additives, except the fiber(s), can be pre-mixed and physically homogenized in low rotation mixers, at ambient temperature.

d. Extruding and Granulating

The extrusion process is responsible for the structural formation of the PHB/PLA polymeric blends. That is, the obtention of the polymeric system morphology, including the distribution, dispersion and interaction of the biodegradable polymers, is defined in this step of the process. In the extruding step also occurs the granulation of the developed materials.

In the extruding step it is necessary the utilization of a modular Twin-Screw Extruder Co-Rotating Intermeshing of the Werner & Pfleiderer type or the like, containing Gravimetric Feeders/Dosage Devices of high precision. The main strategic aspects of the distribution, dispersion and interaction of the biodegradable polymers in the polymeric blend are: the development of the modular screw profile considering the rheologic behavior of the PHB and PLA, the feeding place of the optional natural modifiers, the temperature profile, the extruder flowrate.

The modular screws profile, i.e., the type, number, distribution sequence and adequate positioning of the elements (conveying and mixing) determine the efficiency of the mixture and, consequently, the quality of the polymeric blend, without causing a processing severity which provokes the degradation of the constituent polymers.

Modular screw profiles with pre-established configurations of conveying elements to control the pressure field and kneading elements to control the melting and the mixture (dispersion and distribution of the biodegradable polymers) were utilized. These groups of elements are vital factors to achieve an adequate morphological control of the structure, optimum dispersion and satisfactory distribution of the PHB and PLA.

The optional natural modifiers can be directly introduced in the feeding hopper of the extruder and/or in an intermediary position (fifth barrel), the PHB and PLA polymers already being in the melt state.

The temperature profile of the different heating zones, notably the feeding region and the head region at the outlet of the extruder, and the flowrate controlled by the rotation speed of the screws are also highly important variables.

Table 4 presents the extrusion processing conditions for the compositions of the PHB/PLA polymeric blends.

The granulation for obtaining the granules of the PHB/PLA polymeric blends is made in common granulators, which however can offer an adequate control of the speed and number of blades so that the granules can have the dimensions, which result in a high productivity in the injection molding.

TABLE 4
Extrusion conditions for obtaining the PHB/PLA polymeric
blends

| | Temperature (° C.) | | | | | | | Speed |
|---|---|---|---|---|---|---|---|---|
| | Zone 1 | Zone 2 | Zone 3 | Zone 4 | Zone 5 | Zone 6 | Head | (rpm) |
| PHB/PLA | 120-165 | 125-165 | 140-175 | 150-175 | 150-175 | 150-175 | 150-175 | 140-200 |
| polymeric | | | | | | | | |
| blends | | | | | | | | |

e. Injection Molding or the Manufacture of Several Products

In the injection molding the use of an injecting machine operated through a computer system is required, so as to permit a strict control on the critical variables of this processing method.

Table 5 presents the injection processing conditions for the compositions of the PHB/PLA polymeric blends.

The integration of the injection molding in the developed process is satisfactorily obtained by controlling the critical variables: melt temperature, screw speed during dosage and counter pressure. It there is no strict control of these variables (conditions showed in Table 5), the high shearing inside the gun will give rise to the formation of gas, impeding the dosage homogenization, and jeopardizing the filling of the cavities.

A special attention should also be given to the project of the molds, mainly in the dimensional aspect, in relation to the utilization of the molds with hot chambers, to maintain the polymeric blend in the ideal temperature, and regarding the utilization of submarine channels, as a function of the high shearing resulting from the restricted passage to the cavity.

TABLE 5
Injection conditions of the PHB/PLA polymeric blends

| | Feeding | Zone 2 | Zone 3 | Zone 4 | Zone 5 | |
|---|---|---|---|---|---|---|
| Thermal | 155-165 | 165-175 | 165-175 | 165-175 | 165-175 | ° C. |
| Profile | | | | | | |

| Material | PHB/PLA polymeric blends | |
|---|---|---|
| Injection Pressure | 450-800 | bar |
| Injection Speed | 20-40 | cm³/s |
| Commutation | 450-800 | bar |
| Packing Pressure | 300-550 | bar |
| Packing Time | 10-15 | s |
| Dosage Speed | 8-15 | m/min |
| Counter Pressure | 10-60 | bar |
| Cooling Time | 20-50 | S |
| Mold Temperature | 20-50 | ° C. |

Examples of Properties Obtained for Some Compositions of the Poly (Hydroxybutyrate)-PHB/Poly (Lactic Acid)-PLA Polymeric Blends.

There are presented below examples of Poly (hydroxybutyrate)-PHB/Poly (lactic acid)-PLA NatureWorks PLA polymeric blends, whereas Tables 6-9 present the characterization of these polymeric blends:

### EXAMPLE 1

Polymeric blend of 75% Poly (hydroxybutyrate)-PHB/25% Poly (lactic acid)-PLA NatureWorks PLA (Table 6).

### EXAMPLE 2

Polymeric blend of 50% Poly (hydroxybutyrate)-PHB/50% Poly (lactic acid)-PLA NatureWorks PLA (Table 7).

### EXAMPLE 3

Polymeric blend of 52.5% Poly (hydroxybutyrate)-PHB/17.5% Poly (lactic acid)-PLA NatureWorks PLA, modified with 30% of wood dust or wood flour (Table 8).

### EXAMPLE 4

Polymeric blend of 35% Poly (hydroxybutyrate)-PHB/35% Poly (lactic acid)-PLA NatureWorks PLA, modified with 30% of wood dust or wood flour (Table 9).

TABLE 6
Properties of the polymeric blend of 75% PHB/25% PLA

| | Property/Test | Test Method | Value |
|---|---|---|---|
| 1 | Melt flow Index—MFI | ISSO 1133, | 21 g/10 min |
| | | 230° C./2.160 g | |
| 2 | Density | ISO 1183, A | 1.22 g/cm³ |
| 3 | Tensile strength at yield | ISO 527, | 42 MPa |
| | | 5 mm/min | |
| | Tensile modulus | ISO 527, | 3.500 MPa |
| | | 5 mm/mim | |
| | Elongation at break | ISO 527, | 2.5% |
| | | 5 mm/min | |
| 4 | Izod Impact strength, | ISO 180/1A | 20 J/m |
| | notched | | |

TABLE 7
Properties of the polymeric blend of 50% PHB/50% PLA

| | Property/Test | Test method | Value |
|---|---|---|---|
| 1 | Melt flow Index—MFI | ISO 1133, | 17 g/10 min |
| | | 230° C./2.160 g | |
| 2 | Density | ISO 1183, A | 1.22 g/cm³ |
| 3 | Tensile strength at yield | ISO 527, 5 mm/min | 48 Mpa |
| | Tensile modulus | ISO 527, 5 mm/mim | 3.700 MPa |
| | Elongation at break | ISO 527, 5 mm/min | 2.0% |
| 4 | Izod Impact strength, | ISO 180/1A | 29 J/m |
| | notched | | |

TABLE 8
Properties of the polymeric blend of 52.5% PHB/17.5%
PLA, modified with 30% of wood dust

| | Property/Test | Test method | Value |
|---|---|---|---|
| 1 | Melt flow Index—MFI | ISO 1133, | 15 g/10 min |
| | | 230° C./2.160 g | |
| 2 | Density | ISO 1183, A | 1.24 g/cm³ |
| 3 | Tensile strength at yield | ISO 527, 5 mm/min | 36 MPa |
| | Tensile modulus | ISO 527, 5 mm/mim | 4.500 MPa |
| | Elongation at break | ISO 527, 5 mm/min | 1.5% |
| 4 | Izod Impact strength, | ISO 180/1A | 21 J/m |
| | notched | | |

TABLE 9
Properties of the polymeric blend of 35% PHB/35% PLA,
modified with 30% of wood dust

| | Property/Test | Test method | Value |
|---|---|---|---|
| 1 | Melt flow Index—MFI | ISO 1133, | 9 g/10 min |
| | | 230° C./2.160 g | |
| 2 | Density | ISO 1183, A | 1.24 g/cm³ |
| 3 | Tensile strength at yield | ISO 527, 5 mm/min | 39 Mpa |
| | Tensile modulus | ISO 527, 5 mm/mim | 4.000 MPa |
| | Elongation at break | ISO 527, 5 mm/min | 2.0% |
| 4 | Izod Impact strength, | ISO 180/1A | 24 J/m |
| | notched | | |

1. Environmentally degradable polymeric composition, characterized in that it comprises a biodegradable polymer, defined by poly (hydroxybutyrate)-PHB or copolymers thereof; a poly (lactic acid)-PLA; and optionally at least one of the additives defined by: plasticizer of natural origin, such as natural fibers; and natural fillers.

2. Composition, as set forth in claim 1, characterized in that the plasticizer is an vegetable oil “in natura” (as found in nature) or its ester or epoxi derivative, coming from soybean, corn, castor-oil, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and possible hydrogenated derivatives thereof, present in the composition in a mass proportion lying from about 2% to 30%, preferably from about 2% to about 15%, and more preferably from about 5% to about 10%.

3. Composition, as set forth in claim 2, characterized in that the plasticizer comprises a fatty composition varying from: 45-63% of linoleates, 2-4% of linolenates, 1-4% of palmitates, 1-3% of palmitoleates, 12-29% of oleates, 5-12% of stearates, 2-6% of miristates, 20-35% of palmistates, 1-2% of gadoleates e 0,5-1,6% of behenates.

4. Composition, as set forth in claim 1, characterized in that the utilized natural fibers are selected from: sisal, sugarcane bagasse, coconut, piasaba, soybean, jute, ramie and curaua (Ananas lucidus), present in the composition in a mass proportion lying from about 5% to about 70%, and more preferably, from about 10% to about 60%.

5. Composition, as set forth in claim 1, characterized in that the utilized natural or lignocellulosics fillers are selected from: wood flour or wood dust, starches and rice husk, present in the composition in a mass proportion lying from about 5% to about 70%, and more preferably, from about 10% to about 60%.

6. Composition, as set forth in claim 1, characterized in that the additive further presents at least one of the functions: thermal stabilizer; nucleant; compatibilizer; surface treatment agent; and processing aid.

7. Composition, as set forth in claim 6, characterized in that the compatibilizer is selected from: polyolefine functionalized or grafted with anhydride maleic; ionomer based on copolymer ethylene—acrylic acid or ethylene-methacrylic acid neutralized with sodium (Surlin trademark from DuPont), present in the composition in a mass proportion lying from about 0.01% to about 2%, preferably from about 0.05% to about 1%.

8. Composition, as set forth in claim 6, characterized in that the surface treatment agent is selected from: silane, titanate, zirconate, epoxi resin, stearic acid and calcium stearate, present in the composition in a mass proportion lying from about 0.01% to about 2%.

9. Composition, as set forth in claim 6, characterized in that the processing aid is the “Struktol” product (commercialized by Struktol Company of America), and is present in the composition in a mass proportion lying from about 0.01% to about 2%, preferably, from about 0.05% to about 1%.

10. Composition, as set forth in claim 6, characterized in that the stabilizer is selected from: primary antioxidant, secondary antioxidant or ultraviolet stabilizers of the oligomeric HALS type (sterically hindered amine), present in the composition in a mass proportion lying from about 0.01% to about 2%, preferably from about 0.05% to about 1%, and more preferably from about 0.1% to about 0.5%.

11. Method for obtaining an environmentally degradable polymeric composition, formed by poly (hydroxybutyrate)-PHB or its PHBV copolymers; and a Poly (lactic acid)-PLA, characterized in that it comprises the steps of: a) pre-mixing the constituent materials of the formulation of interest; b) drying said materials; extruding the pre-mixed materials so as to obtain granulation thereof; and c) injection molding the extruded and granulated material for manufacturing of injected packages and other injected products.

12. Method, as set forth in claim 11, characterized in that the pre-mixture include at least one of the additives defined by: plasticizer of natural origin, such as natural fibers; natural fillers; thermal stabilizer; nucleant; compatibilizer; surface treatment agent; and processing aid.

13. Application of the environmentally degradable polymeric composition formed from the mixture of poly (hydroxybutyrate)-PHB/Poly (lactic acid)-PLA, in the manufacture of injected packages for food articles, injected packages for cosmetics, tubes, technical pieces and several injected products.
